(19) United States
(12) Patent Application Publication
(10) Pub. No.: US 2025/0249710 A1
(43) Pub. Date: Aug. 7, 2025

(54) FUNCTIONAL-COMPONENT-ATTACHED ACCOMMODATING BODY AND TIRE

(71) Applicant: THE YOKOHAMA RUBBER CO., LTD., Kanagawa (JP)

(72) Inventor: Takahiro SUZUKI, Kanagawa (JP)

(21) Appl. No.: 18/856,738

(22) PCT Filed: Apr. 14, 2023
(86) PCT No.: PCT/JP2023/015172

§ 371 Date: Oct. 14, 2024

(30) Foreign Application Priority Data
Apr. 20, 2022 (JP) 2022-069240

(51) Int. Cl. B60C 23/04

(52) U.S. Cl. CPC B60C 23/0493

(57) ABSTRACT

Provided is a housing body with a functional component and a tire. A functional component is configured to acquire tire information and a housing body is provided to house the functional component. The housing body includes a bottom portion fixed to a tire inner surface, a side wall portion protruding from the bottom portion, a housing portion formed by the bottom portion and the side wall portion, and an opening portion communicating with the housing portion. At least part of an inner wall surface of the side wall portion has an uneven region composed of a plurality of protruding portions and/or recessed portions.

### TECHNICAL FIELD

The present technology relates to a housing body with a functional component and a tire and particularly relates to a housing body with a functional component and a tire that can improve holding force of a functional component to prevent the functional component from falling off, facilitate work of housing the functional component in the housing body, and avoid degradation of durability of the housing body by devising an internal shape of the housing body housing the functional component.

### BACKGROUND ART

A functional component (for example, a sensor unit including a sensor) configured to acquire tire internal information such as internal pressure or temperature is installed on a tire inner surface (see, for example, Japan Patent No. 6272225 B and Japan Unexamined Patent Publication No. 2016-505438 T). In installing the functional component, a housing body (container) made of rubber or the like is adhered to the tire inner surface, and the functional component is housed inside the adhered housing body. At this time, the housing body is elastically deformed and presses a wall surface of a housing of the functional component to generate friction force, and the functional component is held in the housing body. However, in a case where the friction force is excessively small, for example, the holding force of the housing body with respect to the functional component is weak, the functional component falls off from the housing body when the tire receives a strong impact or the like, or the functional component excessively moves in the housing body to increase heat generation. On the other hand, in a case where the friction force is excessively large, for example, work of housing the functional component in the housing body cannot easily be performed, or the functional component is fixed at an unintended position in housing the functional component, thereby a strong load is applied to the housing body to degrade the durability of the housing body.

### SUMMARY

The present technology provides a housing body with a functional component and a tire that can improve holding force of a functional component to prevent the functional component from falling off, facilitate work of housing the functional component in the housing body, and avoid degradation of durability of the housing body by devising an internal shape of the housing body housing the functional component.

A functional component is configured to acquire tire information and a housing body is provided for housing the functional component. The housing body includes a bottom portion fixed to a tire inner surface, a side wall portion protruding from the bottom portion, a housing portion formed by the bottom portion and the side wall portion, and an opening portion communicating with the housing portion. At least part of an inner wall surface of the side wall portion has an uneven region composed of a plurality of protruding portions and/or recessed portions.

A tire according to an embodiment of the present technology includes the aforementioned housing body with a functional component fixed to a tire inner surface. The functional component is housed in the housing portion.

An embodiment of the present technology is a housing body with a functional component including a functional component configured to acquire tire information and a housing body housing the functional component. The housing body includes a bottom portion fixed to a tire inner surface, a side wall portion protruding from the bottom portion, a housing portion formed by the bottom portion and the side wall portion, and an opening portion communicating with the housing portion. At least part of an inner wall surface of the side wall portion has an uneven region composed of a plurality of protruding portions and/or recessed portions. Therefore, when the functional component is housed in the housing body, a contact area between the surface of the functional component and the inner wall surface of the side wall portion of the housing body is reduced as compared with the case where the uneven region is not provided, thus the friction force on the contact surface between the surface of the functional component and the side wall portion of the housing body is reduced, and the friction force can be appropriately adjusted. This can sufficiently have holding force of the functional component, prevent the functional component from falling off or excessively moving, facilitate work of housing the functional component in the housing body, prevent an excessive load from being applied on the housing body in housing the functional component, and avoid degradation of durability of the housing body.

In the housing body with a functional component according to an embodiment of the present technology, in the uneven region, a maximum height Rz from a recessed portion having a maximum depth to a protruding portion having a maximum height preferably ranges from 10 μm to 2000 μm. This can improve the holding force of the functional component to effectively prevent the functional component from falling off or excessively moving, facilitate the work of housing the functional component in the housing body, prevent an excessive load from being applied on the housing body in housing the functional component, and avoid degradation of durability of the housing body.

A flat surface that has a height of one-half of a maximum height Rz from the recessed portion having a maximum depth to the protruding portion having a maximum height in the uneven region and is parallel to the inner wall surface of the side wall portion is defined as a reference flat surface S, and a total cross-sectional area A that is a sum of cross-sectional areas of the protruding portions on the reference flat surface S and an area As of the reference flat surface S preferably satisfy a relationship 0.2≤A/As≤0.8. This can have appropriate friction force on the contact surface between the surface of the functional component and the side wall portion of the housing body.

At least part of the uneven region is preferably formed in a range of one-half or less of a height hb of the housing portion on the inner wall surface of the side wall portion. This allows the functional component to be easily housed in the housing body and the work of housing the functional component to be effectively improved. In particular, when the uneven region is not provided in the upper half of the side wall portion, the holding force of the functional component can be ensured in the lower half of the side wall portion in which the uneven region is provided, and the motion of the functional component within the housing body can be suppressed to reduce heat generation.

The area A1 of the uneven region and an area A0 of the lower half of the inner wall surface of the side wall portion preferably satisfy a relationship 0.5≤A1/A0≤1.0. This can have appropriate friction force on the contact surface between the surface of the functional component and the side wall portion of the housing body.

Preferably, at least part of the uneven region is continuously formed from a lower half of the inner wall surface of the side wall portion to an upper end of the housing portion. When the functional component is housed in the housing body, air may remain between the housing body and the functional component (for example, between the functional component and the bottom portion) due to close contact between the functional component and the side wall portion of the housing body, and the functional component may not be inserted at an appropriate position. On the other hand, by providing the uneven region as described above, the uneven region continuously formed up to the upper end of the housing portion functions as an air passage, and the remaining air can be discharged through the continuous uneven region, so that the functional component can be inserted into an appropriate position. This can improve the work of housing the functional component.

The protruding portion and/or recessed portion constituting the uneven region are preferably made of vulcanized rubber having a modulus at 100% elongation of 1.0 MPa or more and less than 12.0 MPa. This can provide the durability of the housing body and ease of housing the functional component in the housing body in a compatible manner.

An inclination angle of the side wall portion with respect to the bottom portion measured on an outer wall side of the side wall portion while the functional component is housed in the housing portion is preferably smaller than an inclination angle of the side wall portion with respect to the bottom portion measured on the outer wall side of the side wall portion while the functional component is not housed in the housing portion, and an angle difference between the inclination angles is preferably in a range of 5° to 15°. This can prevent, in the housing body housing the functional component, excessive deformation of the housing body while having the restricting force by which the functional component can be sufficiently restricted. In particular, when the angle difference between the inclination angles before and after the functional component is housed is in the range of 5° to 15°, the restricting force of the housing body with respect to the functional component and the degree of deformation at which the housing body is not damaged are extremely well-balanced. As a result, the housing body can be prevented from being damaged while preventing the functional component from falling off during travel.

A width of the opening portion is preferably smaller than a minimum width of the housing portion, and a circumferential length D2ᵤ of an upper portion of the housing portion and a circumferential length D1ᵤ of an upper portion of the functional component preferably satisfy a relationship 0.60≤ D2ᵤ/D1ᵤ≤0.95. This can increase the restricting force of the housing body with respect to the functional component suppress the motion of the functional component, and can thus prevent the housing of the functional component from being damaged during high-speed travel. In addition, a good balance between the restricting force of the housing body with respect to the functional component and the degree of deformation at which the housing body is not damaged is provided, and thus damage of the housing body can also be prevented.

The tire according to an embodiment of the present technology is preferably a pneumatic tire but may be a non-pneumatic tire. In a case of a pneumatic tire, the interior thereof can be filled with any gas including air and inert gas such as nitrogen.

### BRIEF DESCRIPTION OF DRAWINGS

FIGS. 1A to 1D illustrate an embodiment of a housing body with a functional component according to the present technology. FIG. 1A is a perspective view illustrating an inside of a housing body in which a portion of a side wall portion of the housing body is cut off while the functional component is not housed, FIG. 1B is a cross-sectional view illustrating the entire housing body illustrated in FIG. 1A, FIG. 1C is an enlarged perspective view of an inner wall surface of the side wall portion of the housing body illustrated in FIG. 1A, and FIG. 1D is a cross-sectional view illustrating the entire housing body while the functional component is housed.

FIGS. 2A to 2E are perspective views illustrating other embodiments of an uneven region formed on the inner wall surface of the side wall portion of the housing body.

FIG. 3A is a perspective view for describing the dimensions of the uneven region, and FIG. 3B is a cross-sectional view for describing the dimensions of the uneven region.

FIG. 4 is a cross-sectional view illustrating another embodiment of the housing body with a functional component according to the present technology.

FIG. 5 is a cross-sectional view illustrating another embodiment of the housing body with a functional component according to the present technology.

FIGS. 6A to 6D illustrate an embodiment of the housing body with a functional component before and after the functional component is housed. FIG. 6A is a perspective view illustrating the housing body with a functional component in which the functional component is not housed, FIG. 6B is a cross-sectional view illustrating the housing body with a functional component in which the functional component is not housed, FIG. 6C is a perspective view illustrating the housing body with a functional component in which the functional component is housed, and FIG. 6D is a cross-sectional view illustrating the housing body with a functional component in which the functional component is housed.

FIGS. 7A and 7B are half cross-sectional views of the housing body with a functional component for describing the dimensions of the housing body.

FIG. 8 is a meridian cross-sectional view illustrating an embodiment of a pneumatic tire in which a housing body with a functional component is fixed to a tire inner surface.

FIG. 9 is an enlarged cross-sectional view illustrating the housing body with a functional component of FIG. 8.

### DETAILED DESCRIPTION

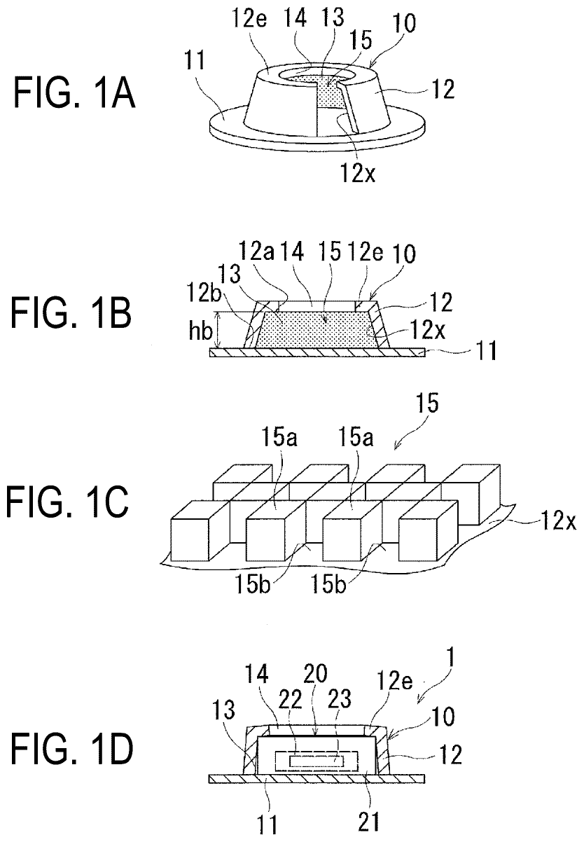

Hereinafter, embodiments of a housing body with a functional component of the present technology will be described in detail with reference to the accompanying drawings. A housing body with a functional component 1 illustrated in FIGS. 1A to 1D includes a functional component 20 configured to acquire tire information and a housing body 10 housing the functional component 20. The housing body with a functional component 1 in FIGS. 1A to 1C includes the housing body 10 in which the functional component 20 is not housed, and the housing body with a functional component 1 in FIG. 1D includes the housing body 10 in which the functional component 20 is housed.

The housing body 10 includes a flat plate-shaped bottom portion 11 fixed to the tire inner surface, a cylindrical side wall portion 12 protruding from the bottom portion 11, a housing portion 13 formed by the bottom portion 11 and the side wall portion 12, and an opening portion 14 communicating with the housing portion 13.

The bottom portion 11 is the longest (and has the maximum diameter) among the portions constituting the housing body 10. The side wall portion 12 is formed to be inclined inward from a direction orthogonal to the bottom portion 11. Accordingly, the housing portion 13 formed by the bottom portion 11 and the side wall portion 12 has a substantially trapezoidal cross-sectional shape. In other words, the cross-sectional width of the housing portion 13 gradually decreases toward an upper portion and becomes smallest at the maximum height position. The side wall portion 12 includes a locking portion 12e formed at one end 12a so as to be bent toward the opening portion 14, and an other end 12b is fixed to the bottom portion 11. After the functional component 20 is housed, the locking portion 12e is brought into contact with an upper surface of the functional component 20 and serves to fix the functional component 20 when the functional component 20 is housed. The width of the opening portion 14 into which the functional component 20 is inserted is smaller than the minimum width of the housing portion 13 in a cross-sectional view (the width at a position adjacent to the opening portion 14).

In FIGS. 1A-ID, each of the bottom portion 11, the side wall portion 12, and the opening portion 14 has a circular planar shape and the housing portion 13 has a truncated cone shape. The planar shapes of the bottom portion 11, the side wall portion 12, and the opening portion 14 are not limited to a particular shape and may be any other planar shape or may be planar shapes different from each other. The shape of the housing portion 13 is not limited to a particular shape, either.

In such a housing body 10, an uneven region 15 forming a fine uneven surface is formed on at least part of an inner wall surface 12x of the side wall portion 12. The uneven region 15 is formed by a plurality of protruding portions 15a and/or recessed portions 15b, and can be formed by regularly arranging the plurality of protruding portions 15a and/or recessed portions 15b. For example, in FIG. 1C, the protruding portions 15a and the recessed portions 15b are alternately arranged so that the plurality of protruding portions 15a adjacent each other do not share a side, thereby forming the uneven region 15. The uneven region 15 may be uniformly provided with the same shape and density over the entire area with respect to the inner wall surface 12x of the side wall portion 12, or may be partially provided with different shapes and densities of unevenness.

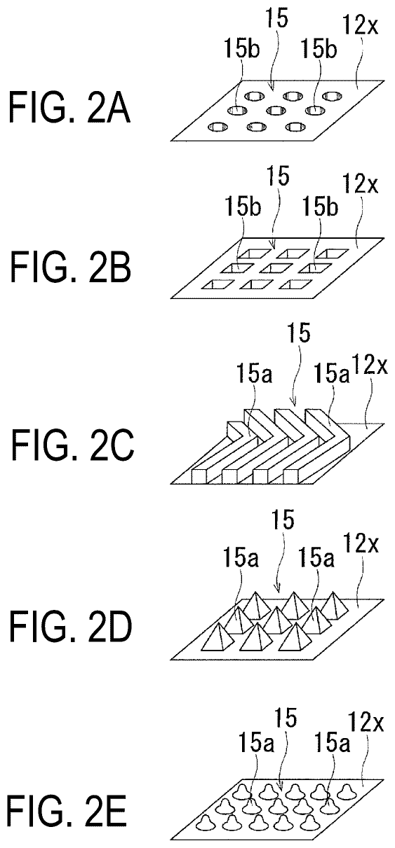

The shape of the uneven region 15 is not particularly limited, and any shape can be adopted. Examples of the uneven region 15 include a cylindrical recessed portion 15b as illustrated in FIG. 2A, a rectangular prism-shaped recessed portion 15b as illustrated in FIG. 2B, a partially bent linear protruding portion 15a as illustrated in FIG. 2C, a quadrangular pyramidal protruding portion 15a as illustrated in FIG. 2D, and a protruding portion 15a having a gradually decreasing diameter toward an end portion formed in a curved surface as illustrated in FIG. 2E.

As illustrated in FIG. 1D, the functional component 20 includes a housing 21 and an electronic component 22. The housing 21 has a hollow structure, and the electronic component 22 is housed therein. The electronic component 22 can include a sensor 23 configured to acquire tire information, a transmitter, a receiver, a control circuit, and a battery as appropriate. Examples of the tire information acquired by the sensor 23 include an internal temperature and an internal pressure of a pneumatic tire and the amount of wear of a tread portion. For example, a temperature sensor or a pressure sensor is used to measure an internal temperature or internal pressure. In a case where a wear amount of the tread portion is detected, a piezoelectric sensor including a piezoelectric element can be used as the sensor 23, and the piezoelectric element detects an output voltage corresponding to tire deformation during travel and detects the wear amount of the tread portion in accordance with the output voltage. Moreover, an acceleration sensor or a magnetic sensor can also be used. The functional component 20 is configured to transmit the tire information acquired by the sensor 23 to the outside of the tire. Furthermore, to easily hold the functional component 20, a knob portion protruding from an upper surface of the housing 21 may be provided, and the knob portion can have a function of an antenna.

The internal structure of the functional component 20 illustrated in FIG. 1D is an example, and the internal structure is not limited to thereto. The sensor 23 may be fixed to the housing body 10 with an adhesive tape, an adhesive, or the like, or may not be fixed to the housing body 10.

In an embodiment of the present technology, the uneven region 15 including the protruding portion 15a and/or the recessed portion 15b and the housing 21 of the functional component 20 are not fitted to each other, the bottom surface of the housing 21 is not provided with a groove, a protruding portion, or a recessed portion, and the side surface of the housing 21 is not provided with a groove, a protruding portion, or a recessed portion to be fitted to the uneven region 15.

The housing body with a functional component described above includes the functional component 20 configured to acquire tire information and the housing body 10 housing the functional component 20. The housing body 10 includes the bottom portion 11 fixed to the tire inner surface, the side wall portion 12 protruding from the bottom portion 11, the housing portion 13 formed by the bottom portion 11 and the side wall portion 12, and the opening portion 14 communicating with the housing portion 13. At least part of the inner wall surface 12x of the side wall portion 12 has the uneven region 15 composed of a plurality of protruding portions 15a and/or recessed portions 15b. Therefore, when the functional component 20 is housed in the housing body 10, a contact area between the surface of the functional component 20 and the inner wall surface 12x of the side wall portion 12 of the housing body 10 is reduced as compared with the case where the uneven region 15 is not provided, so that the friction force on the contact surface between the surface of the functional component 20 and the side wall portion 12 of the housing body 10 is reduced and friction force can be appropriately adjusted. This can sufficiently have holding force of the functional component 20, prevent the functional component 20 from falling off or excessively moving, facilitate work of housing the functional component in the housing body, prevent an excessive load from being applied on the housing body 10 in housing the functional component 20, and avoid degradation of durability of the housing body 10.

In the above-described housing body with a functional component, the protruding portion 15a and/or recessed portion 15b constituting the uneven region 15 are preferably made of vulcanized rubber having a modulus at 100% elongation of 1.0 MPa or more and less than 12.0 MPa. The protruding portion 15a and the recessed portion 15b include such physical properties, and thus the durability of the housing body 10 and ease of housing the functional component 20 in the housing body 10 can be provided in a compatible manner. The uneven region 15 can be made of the same material as the housing body 10. For example, the uneven region 15 may be integrally formed from rubber having hardness different from that of the housing body 10 by using a mold for forming the housing body 10, or the uneven region 15 formed separately from the housing body 10 may be bonded to the inner wall surface 12x of the side wall portion 12 of the housing body 10.

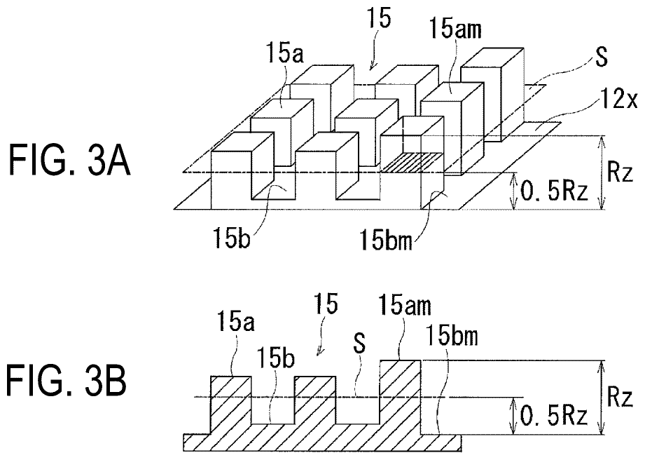

In the above-described housing body with a functional component, the dimensions and the area of the uneven region 15 are preferably set as follows. As illustrated in FIGS. 3A and 3B, a height from a recessed portion 15bm having a maximum depth to a protruding portion 15am having a maximum height in the uneven region 15 is defined as a maximum height Rz. This maximum height Rz is one of the roughness indices of the JIS (Japanese Industrial Standard) and is measured in accordance with JIS-B0601. The maximum height Rz of the uneven region 15 preferably ranges from 10 μm to 2000 μm and more preferably from 100 μm to 2000 μm. Here, in a case where the plurality of recessed portions 15b are formed on the inner wall surface 12x of the side wall portion 12 (for example, see FIG. 2A), the inner wall surface 12x is regarded as the protruding portion 15am having the maximum height, and the maximum height Rz is measured in the same manner as described above.

Appropriately setting the maximum height Rz of unevenness in the uneven region 15 in this manner can improve the holding force of the functional component 20 to effectively prevent the functional component 20 from falling off or excessively moving, facilitate the work of housing the functional component 20 in the housing body 10, prevent an excessive load from being applied on the housing body 10 in housing the functional component 20, and avoid degradation of durability of the housing body 10. Here, if the maximum height Rz of the uneven region 15 is smaller than 10 μm, the height of the protruding portion 15a is not sufficient, and thus the friction force cannot be appropriately adjusted. On the other hand, if the maximum height Rz of the uneven region 15 is larger than 2000 μm, the protruding portion 15a is easily damaged at the time of housing the functional component 20 to degrade the durability, and the work of housing the functional component 20 cannot easily be performed due to too high friction force.

As illustrated in FIG. 3A, in the uneven region 15, a flat surface having a height of one-half (0.5× Rz) of the maximum height Rz and parallel to the inner wall surface 12x of the side wall portion 12 is set as a reference flat surface S. That is, the reference flat surface S is a flat surface having the height of one-half of the maximum height Rz from the recessed portion 15bm having the maximum depth in the uneven region 15. At this time, a total cross-sectional area A that is a sum of cross-sectional areas of the protruding portions 15a on the reference flat surface S, and an area As of the reference flat surface S preferably satisfy the relationship 0.2≤A/As≤0.8. Here, the cross-sectional area of one protruding portion 15a on the reference flat surface S is the area of the shaded portion illustrated in FIG. 3A, and the reference flat surface S can be set arbitrarily. In a case where the plurality of recessed portions 15b are formed on the inner wall surface 12x of the side wall portion 12 (for example, see FIG. 2A), the inner wall surface 12x is regarded as the protruding portion 15am having the maximum height, and the total cross-sectional area A is an area calculated based on the reference flat surface S having the height of one-half of the maximum height Rz in the same manner as described above. As illustrated in FIGS. 3A and 3B, in the uneven region 15, the heights and depths of the protruding portions 15a and the recessed portions 15b do not need to be all the same, and the overall shapes and the cross-sectional shapes on the reference flat surface S of the protruding portions 15a and the recessed portions 15b may be different from each other.

Appropriately setting the ratio of the total cross-sectional area A to the area As in this manner can have appropriate friction force on a contact surface between the surface of the functional component 20 and the side wall portion 12 of the housing body 10. Here, when the ratio of the total cross-sectional area A to the area As is smaller than 0.2, the protruding portion 15a is excessively small in the uneven region 15, and thus the friction force cannot be sufficiently ensured. On the other hand, when the ratio of the total cross-sectional area A to the area As is greater than 0.8, the number of the protruding portions 15a is excessively increased in the uneven region 15, and thus the friction force is excessively increased.

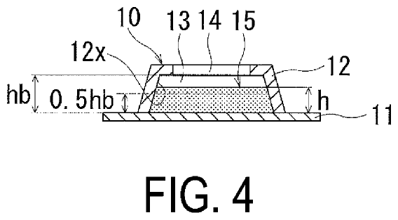

FIG. 4 illustrates another embodiment of the housing body with a functional component of the present technology. In FIG. 4, at least part of the uneven region 15 is formed in the lower half of the inner wall surface 12x of the side wall portion 12. The lower half of the inner wall surface 12x is in a range of one-half (0.5×hb) or less of a height hb of the housing portion 13. In FIG. 4, the uneven region 15 is formed continuously from the lower end of the side wall portion 12, and a height h of the upper end of the uneven region 15 is greater than one-half of the height hb of the housing portion 13, but is not limited thereto. In addition, the uneven region 15 may be formed continuously from the lower end of the side wall portion 12 and the height h of the upper end of the uneven region 15 may be one-half or less of the height hb of the housing portion 13, the uneven region 15 may be locally formed only in the central portion of the inner wall surface 12x so that the upper end and the lower end of the uneven region 15 include one-half of the height hb of the housing portion 13, or the uneven region 15 may be formed in a part of the inner wall surface 12x so that the upper end and the lower end of the uneven region 15 are included in the lower half of the inner wall surface 12x. Here, when the functional component 20 is housed in the housing body 10, the opening portion 14 is widened and the functional component 20 is inserted. At this time, the part of the housing body 10 that comes into contact with the functional component 20 is mainly the lower half of the inner wall surface 12x of the side wall portion 12. Therefore, forming the uneven region 15 in the lower half of the inner wall surface 12x of the side wall portion 12 is beneficial in order to achieve the effects of the present technology. The height hb of the housing portion 13 is a height measured in a state where the functional component 20 is not housed in the housing body 10.

Forming the uneven region 15 in this manner can easily house the functional component 20 in the housing body 10 and effectively improve the work of housing the functional component 20. In particular, when the uneven region is not provided in the upper half of the inner wall surface 12x of the side wall portion 12, the holding force of the functional component 20 can be ensured in the lower half of the inner wall surface 12x of the side wall portion 12 in which the uneven region 15 is provided, and the motion of the functional component 20 within the housing body 10 can be suppressed to reduce heat generation.

Further, the area A1 of the uneven region 15 and an area A0 of the lower half of the inner wall surface 12x of the side wall portion 12 preferably satisfy the relationship 0.5≤A1/A0≤1.0. Here, the area A1 of the uneven region 15 means an area occupied by a portion where the uneven region 15 is disposed in the lower half of the inner wall surface 12x of the side wall portion 12, and is not a surface area in which the shapes of the protruding portion 15a and the recessed portion 15b are taken into consideration. When the uneven region 15 is divided and arranged at a plurality of positions on the inner wall surface 12x, the area A1 of the uneven region 15 is the total area of each arrangement position. Furthermore, when the uneven region 15 is formed to extend beyond the lower half of the inner wall surface 12x of the side wall portion 12, the portion of the uneven region 15 extending beyond the lower half of the inner wall surface 12x is not considered as the area A1 of the uneven region 15. Appropriately setting the ratio of the area A1 to the area A0 in this manner can have appropriate friction force on the contact surface between the surface of the functional component 20 and the side wall portion 12 of the housing body 10. Here, when the ratio of the area A1 to the area A0 is smaller than 0.5, the holding force of the functional component 20 cannot be sufficiently ensured in the lower half of the inner wall surface 12x of the side wall portion 12.

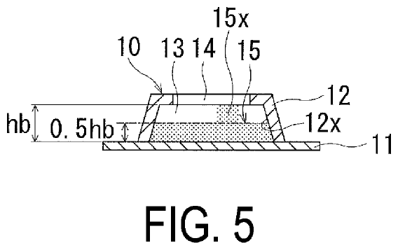

FIG. 5 illustrates another embodiment of the housing body with a functional component of the present technology. In FIG. 5, at least part of the uneven region 15 is formed with a connecting portion 15x that is formed continuously from the lower half of the inner wall surface 12x of the side wall portion 12 to the upper end of the housing portion 13. The connecting portion 15x functions as a passage for air remaining when the functional component 20 is housed.

Here, when the functional component 20 is housed in the housing body 10, air may remain between the housing body 10 and the functional component 20 (for example, between the functional component 20 and the bottom portion 11) due to close contact between the functional component 20 and the side wall portion 12 of the housing body 10, and the functional component 20 may not be inserted at an appropriate position. On the other hand, by forming the connecting portion 15x in a part of the uneven region 15 as described above, the connecting portion 15x functions as an air passage and the remaining air can be discharged, so that the functional component 20 can be inserted into an appropriate position. This can improve the work of housing the functional component 20.

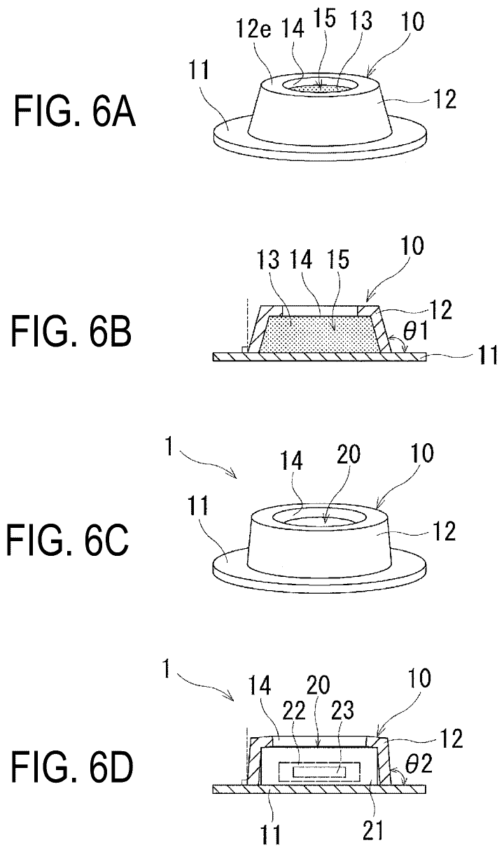

FIGS. 6A to 6D illustrate an embodiment of the housing body with a functional component before and after the functional component is housed. The housing body with a functional component 1 in FIGS. 6A and 6B includes the housing body 10 in which the functional component 20 is not housed, and the housing body with a functional component 1 in FIGS. 6C and 6D includes the housing body 10 in which the functional component 20 is housed.

As illustrated in FIGS. 6A to 6D, in the housing body with a functional component 1, an inclination angle θ2 of the side wall portion 12 with respect to the bottom portion 11 while the functional component 20 is housed in the housing portion 13 is configured to be smaller than an inclination angle θ1 of the side wall portion 12 with respect to the bottom portion 11 while the functional component 20 is not housed in the housing portion 13. Each of the inclination angles θ1, θ2 is an angle measured on the outer wall side of the side wall portion 12. When the functional component 20 is inserted in the housing portion 13 from the opening portion 14, the side wall portion 12 flexes toward the outer side and deforms so as to expand the width of the opening portion 14, and thus the inclination angle θ of the side wall portion 12 with respect to the bottom portion 11 decreases. The angle difference (θ1-θ2) between the inclination angle θ1 before the functional component 20 is housed and the inclination angle θ2 after the functional component 20 is housed is preferably configured to be in the range of 5° to 15°.

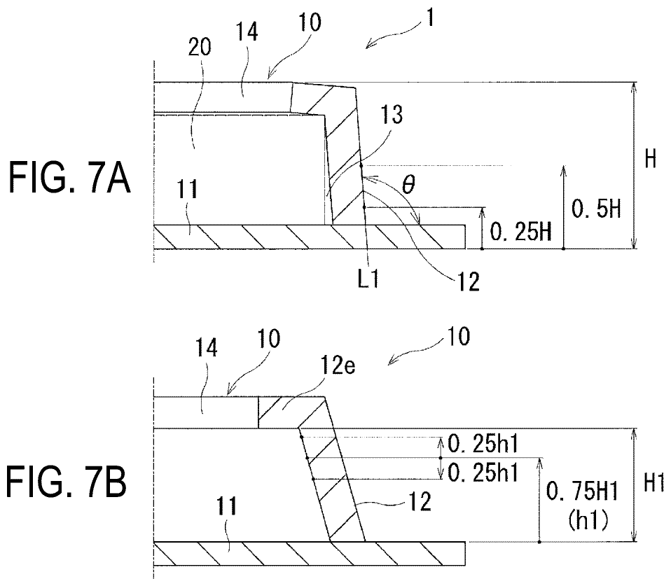

Here, in measuring the inclination angle θ (θ1, θ2) of the side wall portion 12, the angle can be calculated by using a CT scan or the like. Only in measuring the inclination angle θ of the side wall portion 12, as illustrated in FIG. 7A, the inclination angle θ1 before the functional component 20 is housed and the inclination angle θ2 after the functional component 20 is housed are respectively measured by regarding, as the side wall portion 12, a straight line L1 passing through two points corresponding to one-half of a total height H (0.5× H) and one-quarter of the total height H (0.25× H) of the housing body 10 on the outer surface of the side wall portion 12. The total height H (maximum height H) of the housing body 10 changes before and after the functional component 20 is housed, and the inclination angle θ (θ1, θ2) of the side wall portion 12 is measured based on each height. When a projection is formed on the outer surface of the side wall portion 12 at the position corresponding to one-half or one-quarter of the total height H of the housing body 10, the inclination angle θ of the side wall portion 12 is measured based on a straight line defined by using a lower end portion of the projection as a new reference point without including the projection. The total height H of the housing body 10 is a height from a lower surface of the bottom portion 11 to an upper surface of the locking portion 12e.

For the housing body with a functional component 1 as just described, the inclination angle θ2 of the side wall portion 12 with respect to the bottom portion 11 measured on the outer wall side of the side wall portion 12 while the functional component 20 is housed in the housing portion 13 is smaller than the inclination angle θ1 of the side wall portion 12 with respect to the bottom portion 11 measured on the outer wall side of the side wall portion 12 while the functional component 20 is not housed in the housing portion 13. This can prevent, in the housing body 10 housing the functional component 20, excessive deformation of the housing body 10 while having the restricting force by which the functional component 20 can be sufficiently restricted. In particular, when the angle difference (θ1-θ2) between the inclination angles before and after the functional component 20 is housed is in the range of 5° to 15°, the restricting force of the housing body 10 with respect to the functional component 20 and the degree of deformation at which the housing body 10 is not damaged is extremely well-balanced. This can prevent the damage of the housing body 10 while preventing the functional component 20 from coming off during travel.

Here, when the angle difference (θ1-θ2) of the inclination angles is smaller than 5°, the restricting force of the housing body 10 with respect to the functional component 20 is reduced. As a result, the risk of coming off of the functional component 20 during travel increases and the motion of the functional component 20 increases, and thus the durability of the housing body 10 is reduced. On the other hand, when the angle difference (θ1-θ2) between the inclination angles is larger than 15°, the deformation of the housing body 10 becomes excessively large, and cracks are likely to occur in the housing body 10 during long-distance travel.

In particular, the inclination angle θ2 of the side wall portion 12 with respect to the bottom portion 11 while the functional component 20 is housed in the housing portion 13 is preferably 90° or more and more preferably in the range of 90° to 115°. Appropriately setting the inclination angle θ2 after the functional component 20 is housed in this manner can mitigate stress concentration at the base of the side wall portion 12 of the housing body 10 and improve the durability of the housing body 10. Furthermore, the opening portion 14 of the housing body 10 is not excessively narrow, which is suitable for removing the functional component 20.

Here, if the inclination angle θ2 after the functional component 20 is housed is smaller than 90°, stress concentration at the base of the side wall portion 12 of the housing body 10 increases, and strain energy during travel increases. As a result, cracks are likely to occur at the base of the side wall portion 12. On the other hand, if the inclination angle θ2 after the functional component 20 is housed is larger than 115°, the side wall portion 12 is excessively flexed even after the functional component 20 is housed. This makes the width of the opening portion 14 excessively narrow and makes it difficult to remove the functional component 20.

The width of the opening portion 14 is preferably smaller than the minimum width of the housing portion 13, and a circumferential length D2ᵤ of the upper portion of the housing portion 13 and a circumferential length D1ᵤ of an upper portion of the functional component 20 preferably satisfy the relationship 0.60≤D2ᵤ/D1ᵤ≤0.95. In other words, the circumferential length D2ᵤ of the housing portion 13 is set to be smaller than the circumferential length D1ᵤ of the functional component 20 within a specific range, and it is thereby intended to increase restricting force by the housing body 10. Here, as illustrated in FIG. 7B, the circumferential length D2ᵤ of the housing portion 13 is obtained by defining a height of three-quarters of the total inner height H2 (0.75×H1) of the housing body 10 as h1 before the functional component 20 is housed, measuring the circumferential length of the housing portion 13 at a total of three positions including the position of the height h1 and the positions corresponding to +25% of the height h1 (0.25×h1) with reference to the position of the height h1, and averaging the circumferential lengths measured at these three positions. The circumferential length D1ᵤ of the upper portion of the functional component 20 is obtained by measuring the circumferential length of the functional component 20 at positions corresponding to the aforementioned three positions of the functional component 20 and averaging the circumferential lengths measured at these three positions.

Appropriately setting the circumferential length D2ᵤ of the housing portion 13 and the circumferential length D1ᵤ of the functional component 20 in this manner can increase the restricting force of the housing body 10 with respect to the functional component 20 and suppress the motion of the functional component 20, thus allowing the housing 21 of the functional component 20 to be prevented from being damaged during high-speed travel. In addition, a good balance between the restricting force of the housing body 10 with respect to the functional component 20 and the degree of deformation at which the housing body 10 is not damaged is provided, and thus damage of the housing body 10 can also be prevented.

Here, if the ratio D2ᵤ/D1ᵤ is less than 0.60, the restricting force by the housing body 10 increases, but the degree of deformation of the side wall portion 12 also increases. As a result, cracks are generated in the housing body during long-distance travel, and the possibility of damage of the housing body 10 increases. On the other hand, if the ratio D2ᵤ/D1ᵤ is larger than 0.95, the restricting force by the housing body 10 decreases, and the motion of the functional component 20 in the housing body 10 increases. This increases heat generation due to friction between the housing body 10 and the functional component 20, resulting in damage of the housing 21 of the functional component 20.

Further, a circumferential length D2_{O} of the opening portion 14 of the housing body 10 and the circumferential length D1ᵤ of the upper portion of the functional component 20 preferably satisfy the relationship 0.4≤D2_{O}/D1ᵤ≤0.8. Here, the circumferential length D2_{O} of the opening portion 14 is a circumferential length of the opening portion 14 measured in a state where the functional component 20 is not housed in the housing body 10. Appropriately setting the circumferential length D2_{O} of the opening portion 14 and the circumferential length D1ᵤ of the functional component 20 in this manner provides a good balance between the restricting force of the housing body 10 with respect to the functional component 20 and the degree of deformation at which the housing body 10 is not damaged and can improve the durability of the functional component 20 during high-speed travel. Furthermore, the opening portion 14 of the housing body 10 is not excessively narrow, which is suitable for removing the functional component 20.

Here, if the ratio D2_{O}/D1ᵤ is less than 0.4, the opening portion 14 is excessively narrow; and thus it becomes difficult to remove the functional component 20. On the other hand, if the ratio D2_{O}/D1ᵤ is larger than 0.8, the restricting force by the housing body 10 decreases, and the motion of the functional component 20 in the housing body 10 increases. This increases heat generation due to friction between the housing body 10 and the functional component 20, resulting in damage of the housing 21 of the functional component 20.

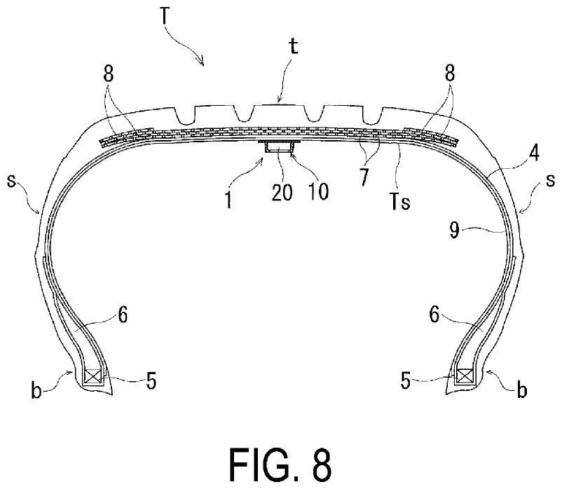

FIG. 8 illustrates a pneumatic tire in which the housing body with a functional component is fixed to a tire inner surface. As illustrated in FIG. 8, a pneumatic tire T includes a tread portion t extending in the tire circumferential direction and having an annular shape, a pair of sidewall portions s disposed on both sides of the tread portion t, and a pair of bead portions b each disposed on an inner side in the tire radial direction of the pair of sidewall portions s.

A carcass layer 4 is mounted between the pair of bead portions b. The carcass layer 4 includes a plurality of reinforcing cords extending in the tire radial direction and is folded back around a bead core 5 disposed in each of the bead portions b from a tire inner side to a tire outer side. A bead filler 6 having a triangular cross-sectional shape and formed of a rubber composition is disposed on the outer circumference of the bead core 5. In addition, an innerliner layer 9 is disposed in an area between the pair of bead portions b on a tire inner surface Ts. The innerliner layer 9 forms the tire inner surface Ts.

Meanwhile, a plurality of belt layers 7 are embedded on the outer circumferential side of the carcass layer 4 in the tread portion t. The belt layers 7 include a plurality of reinforcing cords that are inclined with respect to the tire circumferential direction, and the reinforcing cords are disposed so as to intersect each other between the layers. In the belt layers 7, the inclination angle of the reinforcing cords with respect to the tire circumferential direction is set to fall in a range from 10° to 40°, for example. Steel cords are preferably used as the reinforcing cords of the belt layers 7. To improve high-speed durability, at least one belt cover layer 8 formed by arranging reinforcing cords at an angle of, for example, 5° or less with respect to the tire circumferential direction is disposed on an outer circumferential side of the belt layers 7. Organic fiber cords such as nylon and aramid are preferably used as the reinforcing cords of the belt cover layer 8.

Note that the tire internal structure described above represents a typical example for a pneumatic tire, but the pneumatic tire is not limited thereto.

In the above-described pneumatic tire, the housing body with a functional component 1 can be attached to any portion of the tire inner surface Ts. However, the housing body with a functional component 1 is preferably attached to the tire inner surface Ts corresponding, in particular, to the tread portion t of the tread portion t, the sidewall portions s, and the bead portions b because the housing body with a functional component 1 is less deformed during travel and is unlikely to come off due to centrifugal force applied thereto.

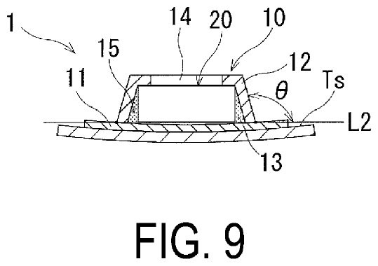

Here, as illustrated in FIG. 9, when the inclination angles θ1 and θ2 are measured in a state where the housing body with a functional component 1 is fixed to the tire inner surface, an angle formed by a straight line L2 passing through the other end 12b of both sides of the side wall portion 12 in a cross-sectional view and the side wall portion 12 is measured. For example, even a housing body with a functional component that is not provided with a member corresponding to a bottom portion and is provided with a side wall portion directly fixed to the tire inner surface can be measured by the same method as described above.

In the aforementioned embodiment, an example in which the housing body with a functional component is attached to the pneumatic tire is described but no such limitation is intended, and the housing body with a functional component can be applied to a non-pneumatic tire.

### EXAMPLES

Tires of Conventional Example and Examples 1 to 7 were manufactured. Each of the tires has a tire size of 225/45R18 and includes a functional component configured to acquire tire information and a housing body housing the functional component. The housing body includes a bottom portion fixed to the tire inner surface, a side wall portion protruding from the bottom portion, a housing portion formed by the bottom portion and the side wall portion, and an opening portion communicating with the housing portion. A housing body with a functional component in which the functional component is housed in the housing body is fixed to the tire inner surface. Presence of the uneven region and the characteristics of the uneven region (maximum height of the unevenness Rz, a density of the unevenness (A/As), upper end height position (h/hb), occupied area, presence of connecting portion, and M100 of the unevenness) were set as indicated in Table 1.

In Table 1, the “upper end height position” is the ratio (h/hb) of the height h of the upper end of the uneven region with regard to the height hb of the housing portion and the value of “1.0” means that the uneven region is arranged from the lower end to the upper end of the side wall portion, while other values mean that the uneven region is continuously arranged from the lower end of the side wall portion to the height of the setting value. “M100 of unevenness” means the modulus at 100% elongation (MPa), is measured in a tensile test at 23° C. in conformance with JIS K6251 (using a dumbbell No. 3), and indicates tensile stress at 100% elongation.

Housing workability, cracking resistance, and high-speed durability of these test tires were evaluated by the following test methods, and the results are shown in Table 1.

### Housing Workability:

For each test tire, time required for the work of housing the functional component in the housing body was measured. Evaluation results are expressed as index values using the reciprocal of the measurement values, with the measured value of Conventional Example expressed as an index value of 100. The larger index values mean shorter required time and superior housing workability.

### Cracking Resistance:

Each of the test tires was mounted on a wheel having a rim size of 18×7 ½JJ, an 80% load of the maximum load capacity was applied after deterioration treatment was performed in the presence of oxygen at 80° C. for five days, and a running test was performed on the tire using a drum testing machine under the condition of air pressure of 250 kPa. Specifically, the speed was increased from an initial speed of 120 km/h by 10 km/h every 24 hours, the tires were run until the crack on the surface of the housing body was confirmed, and running distances when the crack occurred were measured. Evaluation results are expressed as index values with the value of Conventional Example being defined as 100. Larger index values indicate superior cracking resistance.

### High-Speed Durability:

Each of the test tires was mounted on a wheel having a rim size of 18×7 ½JJ, an 88% load of the maximum load capacity was applied, and a running test was performed on the tire using a drum testing machine under the condition of air pressure of 360 kPa. Specifically, the speed was increased from an initial speed of 120 km/h by 10 km/h every ten minutes, and the speed at which an abnormality occurred in the data transmitted from the functional component was measured. Evaluation results are expressed as index values with the measurement value of Conventional Example being defined as 100. Larger index values indicate superior high-speed durability.

TABLE 1

| | | Conventional | Example | Example | Example |
|---|---|---|---|---|---|
| | | Example | 1 | 2 | 3 |
| Presence of uneven region | | No | Yes | Yes | Yes |
| Characteristics | Maximum height Rz of | — | 2500 | 500 | 500 |
| of uneven | unevenness (μm) | | | | |
| region | Density of unevenness | — | 0.9 | 0.9 | 0.6 |
| | (A/As) | | | | |
| | Upper end height | — | 1.0 | 1.0 | 1.0 |
| | position (h/hb) | | | | |
| | Occupied area (A1/A0) | — | 1.0 | 1.0 | 1.0 |
| | Presence of connecting | — | No | No | No |
| | portion | | | | |
| | M100 of unevenness | — | 2.0 | 2.0 | 2.0 |
| | (MPa) | | | | |

| | | | | |
|---|---|---|---|---|
| Housing workability | 100 | 120 | 140 | 160 |
| Cracking resistance | 100 | 110 | 130 | 140 |
| High-speed durability | 100 | 100 | 120 | 130 |

| | | Example | Example | Example | Example |
|---|---|---|---|---|---|
| | | 4 | 5 | 6 | 7 |
| Presence of uneven region | | Yes | Yes | Yes | Yes |
| Characteristics | Maximum height Rz of | 500 | 500 | 500 | 500 |
| of uneven | unevenness (μm) | | | | |
| region | Density of unevenness | 0.6 | 0.6 | 0.6 | 0.6 |
| | (A/As) | | | | |
| | Upper end height position | 0.2 | 0.5 | 0.5 | 0.5 |
| | (h/hb) | | | | |
| | Occupied area (A1/A0) | 0.4 | 1.0 | 1.0 | 1.0 |
| | Presence of connecting | No | No | Yes | Yes |
| | portion | | | | |
| | M100 of unevenness | 2.0 | 2.0 | 2.0 | 3.0 |
| | (MPa) | | | | |

| | | | | |
|---|---|---|---|---|
| Housing workability | 180 | 200 | 240 | 220 |
| Cracking resistance | 150 | 160 | 160 | 180 |
| High-speed durability | 140 | 130 | 130 | 150 |

As can be seen from Table 1, the pneumatic tires of Examples 1 to 7 have improved the housing workability, the cracking resistance, and high-speed durability as compared with the Conventional Example. For the pneumatic tires of Examples 1 to 7, it can be said that the functional component was able to be inserted into an appropriate position when the functional component is housed, resulting in improved cracking resistance and high-speed durability, thus avoiding degradation of durability of the housing body.

The present disclosure includes the following Technologies [1] to [10].

Technology [1] is a housing body with a functional component including: a functional component configured to acquire tire information; and a housing body housing the functional component. The housing body comprises a bottom portion fixed to a tire inner surface, a side wall portion protruding from the bottom portion, a housing portion formed by the bottom portion and the side wall portion, and an opening portion communicating with the housing portion. At least part of an inner wall surface of the side wall portion has an uneven region composed of a plurality of protruding portions and/or recessed portions.

Technology [2] is the housing body with a functional component according to the technology [1], wherein in the uneven region, a maximum height Rz from a recessed portion having a maximum depth of the recessed portions to a protruding portion having a maximum height of the protruding portions ranges from 10 μm to 2000 μm.

Technology [3] is the housing body with a functional component according to the technology [1] or [2], wherein a flat surface that has a height of one-half of a maximum height Rz from a recessed portion having a maximum depth of the recessed portions to a protruding portion having a maximum height of the protruding portions in the uneven region and is parallel to the inner wall surface of the side wall portion is defined as a reference flat surface S, and a total cross-sectional area A that is a sum of cross-sectional areas of the protruding portions on the reference flat surface S and an area As of the reference flat surface S satisfy a relationship 0.2≤A/As≤0.8.

Technology [4] is the housing body with a functional component according to any one of Technologies [1] to [3], wherein at least part of the uneven region is formed in a range of one-half or less of a height hb of the housing portion on the inner wall surface of the side wall portion.

Technology [5] is the housing body with a functional component according to any one of Technologies [1] to [4], wherein an area A1 of the uneven region and an area A0 of a lower half of the inner wall surface of the side wall portion satisfy a relationship 0.5≤A1/A0≤1.0.

Technology [6] is the housing body with a functional component according to any one of Technologies [1] to [5], wherein at least part of the uneven region is continuously formed from a lower half of the inner wall surface of the side wall portion to an upper end of the housing portion.

Technology [7] is the housing body with a functional component according to any one of Technologies [1] to [6], wherein the protruding portions and/or recessed portions constituting the uneven region are made of vulcanized rubber having a modulus at 100% elongation of 1.0 MPa or more and less than 12.0 MPa.

Technology [8] is the housing body with a functional component according to any one of Technologies [1] to [7], wherein an inclination angle of the side wall portion with respect to the bottom portion measured on an outer wall side of the side wall portion while the functional component is housed in the housing portion is smaller than an inclination angle of the side wall portion with respect to the bottom portion measured on the outer wall side of the side wall portion while the functional component is not housed in the housing portion, and an angle difference between the inclination angles is in a range of 5° to 15°.

Technology [9] is the housing body with a functional component according to any one of Technologies [1] to [8], wherein the opening portion has a width smaller than a minimum width of the housing portion, and a circumferential length D2ᵤ of an upper portion of the housing portion and a circumferential length D1ᵤ of an upper portion of the functional component satisfy a relationship 0.60≤D2ᵤ/D1ᵤ≤0.95.

Technology is a tire including the housing body with a functional component according to any one of Technologies [1] to [9] fixed to the tire inner surface. The functional component is housed in the housing portion.

1. A housing body with a functional component, the housing body comprising:
a functional component configured to acquire tire information; and
a housing body housing the functional component;
the housing body comprising a bottom portion fixed to a tire inner surface, a side wall portion protruding from the bottom portion, a housing portion formed by the bottom portion and the side wall portion, and an opening portion communicating with the housing portion, and
at least part of an inner wall surface of the side wall portion having an uneven region composed of a plurality of protruding portions and/or recessed portions.

2. The housing body with a functional component according to claim 1, wherein in the uneven region, a maximum height Rz from a recessed portion having a maximum depth of the recessed portions to a protruding portion having a maximum height of the protruding portions ranges from 10 μm to 2000 μm.

3. The housing body with a functional component according to claim 1, wherein
a flat surface that has a height of one-half of a maximum height Rz from a recessed portion having a maximum depth of the recessed portions to a protruding portion having a maximum height of the protruding portions in the uneven region and is parallel to the inner wall surface of the side wall portion is defined as a reference flat surface S, and
a total cross-sectional area A that is a sum of cross-sectional areas of the protruding portions on the reference flat surface S and an area As of the reference flat surface S satisfy a relationship 0.2≤A/As≤0.8.

4. The housing body with a functional component according to claim 1, wherein at least part of the uneven region is formed in a range of one-half or less of a height hb of the housing portion on the inner wall surface of the side wall portion.

5. The housing body with a functional component according to claim 1, wherein an area A1 of the uneven region and an area A0 of a lower half of the inner wall surface of the side wall portion satisfy a relationship 0.5≤A1/A0≤1.0.

6. The housing body with a functional component according to claim 1, wherein at least part of the uneven region is continuously formed from a lower half of the inner wall surface of the side wall portion to an upper end of the housing portion.

7. The housing body with a functional component according to claim 1, wherein the protruding portions and/or recessed portions constituting the uneven region are made of vulcanized rubber having a modulus at 100% elongation of 1.0 MPa or more and less than 12.0 MPa.

8. The housing body with a functional component according to claim 1, wherein
an inclination angle of the side wall portion with respect to the bottom portion measured on an outer wall side of the side wall portion while the functional component is housed in the housing portion is smaller than an inclination angle of the side wall portion with respect to the bottom portion measured on the outer wall side of the side wall portion while the functional component is not housed in the housing portion, and
an angle difference between the inclination angles is in a range of 5° to 15°.

9. The housing body with a functional component according to claim 1, wherein
the opening portion has a width smaller than a minimum width of the housing portion, and
a circumferential length D2ᵤ of an upper portion of the housing portion and a circumferential length D1ᵤ of an upper portion of the functional component satisfy a relationship 0.60≤D2ᵤ/D1ᵤ≤0.95.

10. A tire, comprising
the housing body with a functional component according to claim 1 fixed to the tire inner surface;
the functional component being housed in the housing portion.

11. The housing body with a functional component according to claim 2, wherein
a flat surface that has a height of one-half of a maximum height Rz from a recessed portion having a maximum depth of the recessed portions to a protruding portion having a maximum height of the protruding portions in the uneven region and is parallel to the inner wall surface of the side wall portion is defined as a reference flat surface S, and
a total cross-sectional area A that is a sum of cross-sectional areas of the protruding portions on the reference flat surface S and an area As of the reference flat surface S satisfy a relationship 0.2≤A/As≤0.8.

12. The housing body with a functional component according to claim 11, wherein at least part of the uneven region is formed in a range of one-half or less of a height hb of the housing portion on the inner wall surface of the side wall portion.

13. The housing body with a functional component according to claim 12, wherein an area A1 of the uneven region and an area A0 of a lower half of the inner wall surface of the side wall portion satisfy a relationship 0.5≤A1/A0≤1.0.

14. The housing body with a functional component according to claim 13, wherein at least part of the uneven region is continuously formed from a lower half of the inner wall surface of the side wall portion to an upper end of the housing portion.

15. The housing body with a functional component according to claim 14, wherein the protruding portions and/or recessed portions constituting the uneven region are made of vulcanized rubber having a modulus at 100% elongation of 1.0 MPa or more and less than 12.0 MPa.

16. The housing body with a functional component according to claim 15, wherein
an inclination angle of the side wall portion with respect to the bottom portion measured on an outer wall side of the side wall portion while the functional component is housed in the housing portion is smaller than an inclination angle of the side wall portion with respect to the bottom portion measured on the outer wall side of the side wall portion while the functional component is not housed in the housing portion, and
an angle difference between the inclination angles is in a range of 5° to 15°.

17. The housing body with a functional component according to claim 16, wherein
the opening portion has a width smaller than a minimum width of the housing portion, and
a circumferential length D2ᵤ of an upper portion of the housing portion and a circumferential length D1ᵤ of an upper portion of the functional component satisfy a relationship 0.60≤D2ᵤ/D1ᵤ≤0.95.

18. A tire, comprising
the housing body with a functional component according to claim 17 fixed to the tire inner surface;
the functional component being housed in the housing portion.
